(19) United States
(12) Patent Application Publication
(10) Pub. No.: US 2003/0006604 A1
(43) Pub. Date: Jan. 9, 2003

(54) Detachable bilingual information cards for travelers

(76) Inventor: Patrick Wayne Bennett, Buffalo Grove, IL (US)

Correspondence Address: PATRICK W. BENNETT, 277 CHICORY LANE, BUFFALO GROVE, IL, 60089, US

(21) Appl. No.: 09/898,382

(22) Filed: Jul. 5, 2001

(51) Int. Cl. G09B 17/02

(52) U.S. Cl. 283/46

(57) ABSTRACT

A travel publication containing a collection of detachable information cards that provides the consumer information in regards to finding a specific location at a destination where the consumer is hindered by a language or accent barrier. Each card details a specific location or locations in both text and a graphical map. This information is presented in a bilingual format using both the written language that the consumer is skilled in and the common written language of the destination. After detachment, the card is handed to a person(s) at the destination and used to communicate the consumer's desire to find or be transported to that specific location.

### CROSS-REFERENCES TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

This invention relates to printed matter, specifically to such printed matter that provides the consumer, in the form of a detachable card, bilingual information in regards to finding a specific location at a destination where the consumer is hindered by a language and or accent barrier.

Travel publications/advertisements, travel agencies, and tourist information offices by nature supply the consumer with information on destinations and attractions that would entice the consumer to visit such places. This information helps the consumer select destinations that they would favor visiting. However, when the consumer selects a destination that presents a language barrier to the consumer, the aforementioned information is inadequate. After arriving at a destination, the consumer requires transportation, or at the very least, directions on how to get to a specific location. Without the necessary language skills to communicate the consumer's needs, the consumer encounters great difficulty navigating through the destination.

Consumers have responded in a variety of ways, such as avoiding certain destinations; researching public transportation routes and schedules; learning the necessary language skills; traveling with individuals who posses the necessary language skills; traveling on group tours that provide transportation to specific locations on a fixed itinerary; hiring an individual tour guide. Each of the above solutions are flawed by either forcing the consumer to deal with the unpleasant aspects of public transportation; requiring large amounts of time to be invested prior to travelling; limiting the specific locations the consumer will experience; and/or increasing the expense of travelling to that destination.

Individual establishments have responded in two known ways. The first is in the form of a business card. It is a common practice in parts of Asia for hotels and a limited number of other establishments to provide the consumer with their business card after consumer's arrival. This business card is of a bilingual, and sometimes a trilingual nature. It displays the business' name, address, and other pertinent information on the front side. On the back side, it displays a graphical map of the nearby area to assist the consumer in returning to that individual establishment's specific location. The intended use of this business card is for the consumer to hand it to a taxi operator, thereby communicating the consumer's desire to be returned to that location. The taxi operator, possessing sufficient language skills of the destination, reads the business card, understands its meaning, and transports the consumer to that specific location. This solution is ideal for travelers that need transportation or directions to return to a specific location, such as their hotel room at the end of the day. It fails though to assist the consumer in finding the location the first time, such as when the consumer arrives at the airport and needs to check in to the hotel.

The second method individual establishments have responded with is to provide this information prior to the consumer's arrival at the destination. After contacting the individual establishment, the consumer requests or is offered to have the aforementioned business card mailed to the consumer. In a limited number of incidences, the consumer may find an internet web page pertaining to a specific location that contains the same information as the business card. This web page could then be printed out and carried with the consumer to the destination.

These two methods were designed as a solution to benefit the individual establishment and not the consumer. The consumer would need to invest a considerable amount of time and effort in researching what specific locations the consumer would like to experience and then contacting each one of them. Because the consumer lacks the necessary language skills of the destination, contact with the specific location would be difficult and might be limited to internet web sites presented in the consumer's language. The web pages containing this bilingual information are extremely limited and again designed to benefit the individual establishment. Numerous establishments do not have a presence on the internet, and specific locations that are not part of an establishment would not have a business need to have a web site.

### BRIEF SUMMARY OF THE INVENTION

A travel publication containing a collection of detachable information cards that provides the consumer information in regards to finding a specific location at a destination where the consumer is hindered by a language or accent barrier. Each card details a specific location or locations in both text and a graphical map. This information is presented in a bilingual format using both the written language that the consumer is skilled in and the common written language of the destination. After detachment, the card is handed to a person(s) at the destination and used to communicate the consumer's desire to find or be transported to that specific location.

Accordingly, several objects and advantages of my invention are:

(a) provides a comprehensive collection of specific locations for the consumer to pick and choose,

(b) enables the consumer to choose a destination irrespective of the language skills of the consumer or of the language spoken at the destination,

(c) eliminates the near impossible task for the consumer to research and gather this information on their own,

(d) removes the consumer's need to research and then carry around information regarding mass public transportation such as bus and train schedules,

(e) removes the consumer from the unpleasant and potentially dangerous situations often associated with mass public transportation,

(f) reduces or removes the consumer's need to acquire language skills before arriving at the destination,

(g) reduces or removes the problem that even a consumer that speaks the same language has with proper pronunciation and heavy accents,

(h) overcomes some handicaps the consumer may have in regards to actually speaking or hearing,

(i) removes the consumer's dependency on tour operators to get from one location to the next,

(j) by traveling independent of a tour operator, the consumer is in full control of his/her travel budget,

(k) the consumer is in complete control of their travel itinerary, changing it spontaneously as needed, for such reasons as closed attractions, inclement weather, and travel sicknesses,

(l) being able to get back to a specific location if the consumer gets lost or disoriented, should embolden the consumer to experience parts of a destination that might have gone unexplored

(m) convenient size for handling and storage Still further objects and advantages will become apparent from a consideration of the descriptions and drawings.

### BRIEF DESCRIPTION OF THE SEVERAL VIEWS OF THE DRAWING:

FIG. 1, the front of the card, shows the card attached to the publication and the text related to the specific location.

FIG. 2, the back of the card, shows the card detached from the publication and the graphical map related to the specific location.

### DETAILED DESCRIPTION OF THE INVENTION:

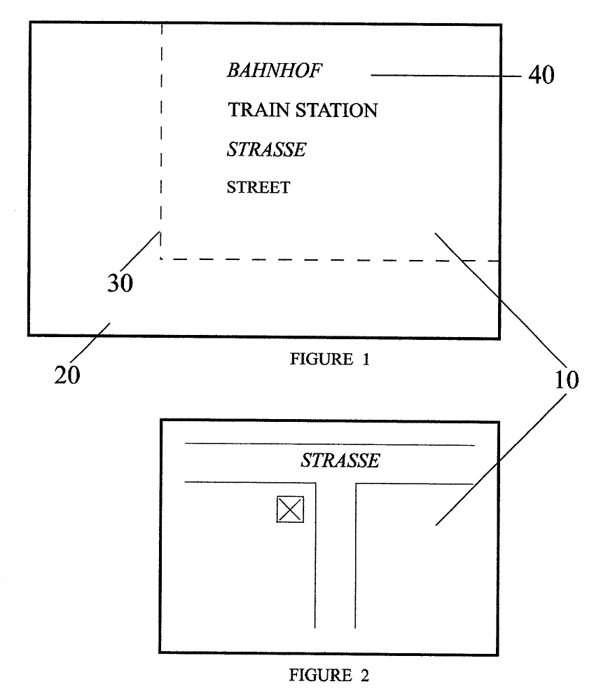

The preferred embodiment of the card (10) of the present invention is illustrated in FIG. 1 the front view, and FIG. 2 the back view. The card (10) itself is detachable from the publication (20) by means of perforations (30) which are manually torn along. Typically the detached card (10) is approximately the size of a standard business card, but is not limited to these dimensions. The card (10), and hence the publication (20) itself if both are of the same page, should be made from paper stock that is heavier (thicker) than standard paper but does not need to be as heavy as a standard business card. The publication (20) can have one or many cards (10), on one or many pages, or the cards (10) can be segregated to their own section of the publication (20). The position of the card (10) on the page can be determined by the function of the publication (20) and the consumer's ease of use.

The front of the card (10), FIG. 1, contains the text (40) relating to the specific location or locations in both the written language that the consumer is skilled in and the common written language spoken at the destination. This text (40) should contain, but is not limited to, the location's name and address.

The back of the card (10), FIG. 2, contains the graphical map representing how to find the location using the common written language for the destination and optionally the written language that the consumer is skilled in.

I claim:

1. A bilingual information card for travelers, comprising:
(a) a collection of pages,
(b) said pages being loose or attached,
(c) said page possessing a single or a plurality of cards, each having means for detachment from said page,
(d) said card containing both text characters and a single or a plurality of graphical images,
(e) said text and said graphical image(s) being printed on one or both sides of said card,
(f) said text characters being printed in the written language that is common for the destination, and optionally the written language that the consumer is skilled in,
(g) said graphical image(s) consists of, but not limited to, a graphical map image,
(h) said graphical map image is a visual geographical representation of an area large enough for an individual to understand the location of a single or a plurality of specific locations.
